(19) United States
(12) Patent Application Publication
(10) Pub. No.: US 2024/0306711 A1
(43) Pub. Date: Sep. 19, 2024

(54) VAPORIZER APPARATUS

(71) Applicant: David Yunsong Guo, Richmond, TX (US)

(72) Inventor: David Yunsong Guo, Richmond, TX (US)

(21) Appl. No.: 18/605,040

(22) Filed: Mar. 14, 2024

Related U.S. Application Data
(60) Provisional application No. 63/452,437, filed on Mar. 15, 2023.

(51) Int. Cl. A24F 40/42; A24F 7/02; A24F 40/05; A24F 40/10; A24F 40/20; A24F 40/46; A24F 40/465; A24F 40/48; A24F 40/51; H05B 6/10

(52) U.S. Cl. CPC A24F 40/42; A24F 7/02; A24F 40/05; A24F 40/10; A24F 40/20; A24F 40/46; A24F 40/465; A24F 40/48; A24F 40/51; H05B 6/108

(57) ABSTRACT

A device for vaporizing and/or atomization of active substances in the form of liquid, thick liquid, wax, and semi-solids. The device includes a body assembly that encases different components, an airflow module that attaches to the body assembly, and a cartridge module. The cartridge module can be inserted into a body of the body assembly and includes a container and an aerosolization element. The aerosolization element is primarily for vaporizing the active substance through inductive heating. The aerosolization element can freely slide within the container up and down longitudinally. The aerosolization element may optionally include pores for aerosolized particles to pass through but the size of pores prevents the active substances from passing through, thus acting as a cap. The aerosolization element remains in contact with a top surface of the active substances through adhesive forces and moves with change in level of the active substances.

### CROSS-REFERENCE TO RELATED APPLICATIONS

This application claims priority from a U.S. Provisional Patent Appl. Ser. No. 63/452,437, filed on Mar. 15, 2023, which is incorporated herein by reference in its entirety.

### FIELD OF INVENTION

The present invention relates to an apparatus for generating vapors/aerosol, and more particularly, the present invention relates to vapors/aerosol generating apparatus for delivering active substances in vapor/aerosol form to a user.

### BACKGROUND

Vaporizers and nebulizers on the market are widely used for both recreational and medical uses. Substances in the form of liquid, semi-solid, gel, and solid forms can be vaporized or atomized. Different vaporization and atomization mechanisms are used depending on the nature of the substance to be vaporized or atomized. For example, medical atomizers, commonly referred to as “nebulizers” are used for atomizing liquid substances and use some form of ultrasonic element for atomization. Nebulizers are not suitable for thick liquids, semi-solids, gels, powders, and the like substances. Thick liquids, semi-solids, gels, powders, and the like are generally vaporized using a heating element. Chiefly the vaporizers tend to employ electrical resistor heating to vaporize liquids, oil, or gel-like materials, such as resin, wax, etc. Because the vaporizers need relatively high temperatures (180-290° C.), the instability introduced by heat causes all sorts of leakage problems. Resolving the leakage problem tends to have a trade-off with lowering the quality of the vapor produced. For example, by restricting liquid outflow and air inflow to the liquid container, often carbon buildups collect on the heating elements, and in severe scenarios, this can cause “dry burns” of the wicks. If the manufacturer chooses to sacrifice leakage for better flavor and purer aerosolization, the leakage issue that plagues many devices can present other unwanted health risks besides just wasting away money.

For example, the majority of recreational, distillate cartridge vaporizers use porous ceramic heating elements which are subject to micro-fracturing, and ceramic particles generated can be inhaled by the user. Moreover, various wicks made from fiberglass, plastic fibers or cotton are subject to fracturing or carcinogenic combustion during heating, causing users to inhale harmful, carcinogenic debris. Not to mention, the smell and taste of such polluting particulates can also be detestable to the users.

Conventional cartridges of various vaporizers (most rely on resistor heating) commonly utilize a liquid container, which contains or is connected to a structure that houses a heating element. The heating element may be a porous, metal-printed element surrounded by wicking materials, or it may be a metal coil, or a similar structure made from sheet metal, wrapped by, or wrapping wicks or other mediums of transporting the fluid to the heating element. The position of the heating element along with the wicks or porous mediums must usually be placed near the bottom of the liquid container. Therefore, if there is any leakage in the liquid container so that air can flow into it, the material within the container leaks outwards into the air pathways of the cartridge. If the liquid is thick, it clogs the airflow pathways. If the liquid is thin, it travels directly into the user's mouth.

The number of components necessary to create such conventional cartridges adds to the creation of unnecessary risk of leakage, especially during mass production. Additionally, the liquid or gel used in many applications can be very thick and have high viscosity. In such applications, this inevitably means cartridge manufacturers must introduce some built-in air leakage into the liquid container, or the pressure gradient towards leakage must be very weak. Otherwise, the material will not flow or travel to the heating element fast enough, resulting in unwanted combustion of the cartridge materials. Thus, the hazard of unwanted leakage is almost unavoidable in the conventional oil, distillate, or e-liquid cartridges found commonly in the marijuana cartridge systems on the market to date. As mentioned previously, if such devices prevent leakage, then the tradeoff is unwanted combustion of various materials in the atomizer, or at the very least a significantly lower vapor production of the atomizer (to match the slower rate of liquid supplied to the heating element).

Thus, a need is appreciated for a novel apparatus for generating aerosols that overcome the aforesaid drawbacks with conventional vaporizing systems.

Hereinafter, the terms “vapor” and “aerosol” are interchangeably used and refer to substances in the gas phase, the substance can be solid, particles, liquid droplets, and the like. The meaning should be interpreted depending on the context in which it is used.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an induction-powered vaporizer system.

Another object of the present invention is that the generation of harmful and carcinogenic substances is significantly reduced.

Still, another object of the present invention is that the heating mechanism does not significantly affect the taste and aroma of vapors generated upon heating the active substances.

Yet another object of the present invention is that the system is economical to manufacture.

A further object of the present invention is that the aerosolizer system allows for the simpler construction of a cartridge.

Still, a further object of the present invention is that any risk of leakage from the cartridge can be significantly reduced.

In one aspect, disclosed is a cartridge-based induction-powered vaporizer system that eliminates wicks or the intermediate materials that connect the liquid to the heating element.

Disclosed is a cartridge-based induction-powered vaporizer system that enables the utilization of wax, gel, and similar highly viscous material to be vaporized. The cartridge can contain highly viscous substances.

In one aspect, disclosed is a cartridge comprising a container configured for containing an active substance, and an aerosolizing element configured to be received within the container. The container comprises at least one opening in a wall or top of the container, where the at least one opening is positioned above the aerosolizing element. The container further comprises at least one inner wall parallel to a longitudinal axis of the container wherein the aerosolizing element is configured to freely slide within the container along the longitudinal axis of the container. The aerosolizing element comprises at least one side wall configured to remain relatively parallel to the longitudinal axis of the container, wherein the at least one side wall is of a sufficient height such that to prohibit the aerosolizing element from turning over inside the container.

In one aspect, the cartridge comprises an airflow structure comprising at least one air outlet and at least one air inlet; and the airflow structure further comprises a hollow region that fluidly connects the at least one air outlet, the at least one air inlet, and the at least one opening in the container.

In one aspect, the at least one opening of the container is in the wall of the container and positioned nearby the top of the container.

In one aspect, the aerosolizing element is configured to be in contact with the active substance contained in the container and move downwards with changes in a level of the active substance.

In one aspect, the aerosolizing element comprises at least one opening to allow for the active substance in an aerosolized form to escape, wherein the at least one opening in the aerosolizing element is of a circular shape or a slit shape.

In one aspect, the aerosolizing element comprises at least one mesh structure.

In one aspect, the aerosolizing element comprises at least one air cavity, whereas at least one air cavity is configured to enable the aerosolizing element to float over the active substance when the active substance is in a liquid state.

In one aspect, the aerosolizing element comprises a piezoelectric element, whereas the piezoelectric element aerosolizes the active substance using ultrasonic waves.

In one aspect, the aerosolizing element comprises an electrical resistor, whereas the electrical resistor vaporizes the active substance through electrical heating.

In one aspect, the aerosolizing element comprises a plurality of pores, whereas the plurality of pores allows for aerosolized particles or vapors to pass through.

In one aspect, the cartridge comprises the active substance contained in the container, wherein the active substance is in a form of a gel, semi-solid, paste, or solid state at room temperature, and the aerosolizing element is configured to liquify at least a layer of the active substance in contact with the aerosolizing element through heating.

In one aspect, the cartridge comprises the active substance contained in the container, wherein the active substance is in liquid form at room temperature.

In one aspect, the at least one side wall of the aerosolizing element and the at least one inner wall of the container are configured to form a peripheral gap around the aerosolizing element.

In one aspect, the aerosolizing element is configured to float over the active substance in the container, wherein the peripheral gap is configured to draw and be filled with the active substance in a liquid state, through adhesive forces existing between contacting surfaces of a liquid and solid, wherein the drawn active substance is further configured to act as a barrier preventing a bulk of the active substance stored below the aerosolizing element from leaking out of the container.

In one aspect, the aerosolizing element is configured to be powered by an induction field.

In one aspect, the aerosolizing element is powered by an induction field by further converting electromagnetic energy of the induction field into heat, which vaporizes the active substance.

In one aspect, the aerosolizing element comprises at least one ferrous material.

In one aspect, the aerosolizing element further comprises at least one nonferrous material.

In one aspect, disclosed is an apparatus comprising a cartridge, a body assembly comprising an accessible cavity region to receive the cartridge at least partially, and an airflow structure removably attachable to the body assembly. The cartridge comprises a container configured for containing an active substance and an aerosolizing element configured to be received within the container. The container comprises at least one opening in a wall or top of the container and at least one inner wall parallel to a longitudinal axis of the container, wherein the aerosolizing element is configured to freely slide along the longitudinal axis of the container. The at least one opening of the container is positioned above the aerosolizing element. The aerosolizing element comprises at least one side wall configured to remain relatively parallel to the longitudinal axis of the container, wherein the at least one side wall is of a sufficient height such that to prohibit the aerosolizing element from turning over inside the container. The airflow structure comprises at least one first opening for airflow to enter the airflow structure, at least one second opening for air to exit the airflow structure, and at least one hollow cavity.

In one aspect, at least one hollow cavity of the airflow structure has an opening, the opening is configured to removably receive a portion of the cartridge into the airflow structure.

In one aspect, at least one first opening and the at least one second opening are configured to fluidly connect to the aerosolizing element of the cartridge.

In one aspect, the body assembly comprises an induction work coil at least partially surrounding the accessible cavity region, a compartment for holding a power supply, and at least one circuit board electrically connected to the induction work coil and the power supply. The induction work coil is configured to supply power wirelessly to the cartridge, and the power supply is configured to provide electrical energy for operating the apparatus.

In one aspect, the body assembly further comprises a gyro sensor, whereas the gyro sensor is configured to sense an orientation of the apparatus.

In one aspect, the body assembly further comprises at least one temperature sensor, the at least one temperature sensor is configured to help determine an amount of power to be supplied to the cartridge.

In one aspect, the airflow structure further comprises a mouthpiece.

In one aspect, the airflow structure is configured to lock onto the body assembly by a twisting motion.

In one aspect, the airflow structure is configured to attach to the body assembly through magnetic force.

In one aspect, the airflow structure is configured to attach to the body assembly by frictional force.

In one aspect, disclosed is a device for vaporization and/or atomization of an active substance. The device comprises a body assembly, an aerosolizing element, an induction work coil, at least one circuit board electrically connected to the induction work coil, a compartment for holding a power supply, and an airflow structure configured to removably connect with the body assembly. The body assembly comprises a containing volume that is open at a top and has at least one inner wall parallel to a longitudinal axis of the containing volume. The containing volume is configured to directly contact and contain the active substance, whereas the active substance is configured to be aerosolized in the containing volume. The aerosolizing element configured to freely slide within the containing volume along the longitudinal axis of the containing volume. The aerosolizing element comprises at least one side wall configured to remain relatively parallel to the at least one inner wall of containing volume, and at least one air cavity configured to enable the aerosolizing element to float above the active substance in its liquid state. The at least one side wall is configured to have sufficient height to prohibit the aerosolizing element from turning over inside the containing volume. The induction work coil configured to be at least partially surrounding the containing volume. The airflow structure comprises at least one air inlet and at least one air outlet. The at least one air outlet is configured to fluidly connect to the at least one air inlet and the containing volume of the body assembly when the airflow structure is connected to the body assembly.

In one aspect, the aerosolizing element is configured to be powered by the induction work coil of the body assembly.

In one aspect, at least a portion of the at least one air outlet of the airflow structure is a flexible and hollow tube.

In one aspect, the airflow structure comprises at least one hollow cavity, whereas the at least one hollow cavity is further configured to fluidly connect to the at least one air inlet, the at least one air outlet, and the containing volume of the body assembly when the airflow structure is connected to the body assembly.

In one aspect, disclosed is an aerosolizing element for the vaporization and/or atomization of an active substance. The aerosolizing element comprises a capsule structure that at least partially encloses a cavity, and at least one workpiece structure extending at least partially into the cavity, whereby the at least one workpiece structure is coupled to the capsule structure. The workpiece structure comprises a ferrous material that can generate heat under an alternating magnetic field. The shape capsule structure, the mass of the aerosolizing element, and the volume of the cavity are configured such that the aerosolizing element can float in a liquid having a density of at least 0.5 g/cm³.

In one aspect, the capsule structure is comprised of a cap and a cup, where the cap and cup are coupled together to at least partially enclose the cavity.

In one aspect, the capsule structure is comprised of a tube and two caps, where the tube and two caps are coupled together to enclose the cavity at least partially.

In one aspect, the capsule structure comprises a nonferrous material.

In one aspect, the capsule structure comprises at least one hole at the top, where the at least one hole fluidly connects the cavity to the environment exterior to the capsule structure.

In one aspect, at least a portion of the at least one workpiece structure is in a cylindrical shape.

In one aspect, at least a portion of the at least one workpiece structure has a thickness of at least 0.1 mm.

In one aspect, the aerosolizing element comprises at least one heat-sink structure that is coupled to the capsule structure, and the at least one workpiece structure is coupled to the heat-sink structure.

In one aspect, the at least one heat-sink structure comprises a material having a thermal conductivity of at least 100 W/mK.

In one aspect, the workpiece structure is configured to not directly contact the capsule structure.

In one aspect, the at least one heat-sink structure comprises a ring-structure and at least one hollow tube structure, and the ring structure and at least one hollow tube structure are coupled together.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1a shows a front view of the system, FIG. 1b shows a sectional view of the system taken along line A-A, and FIG. 1c shows an exploded view of the system showing a body, cartridge, and a mount piece, according to an exemplary embodiment of the present invention.

FIG. 2b shows the cartridge, FIG. 2c shows a sectional view of the cartridge taken along line B-B of FIG. 2b, and FIG. 2a shows an exploded view showing a container filled with active substance, according to an exemplary embodiment of the present invention.

FIG. 3a is an exploded view of the aerosolizing element; FIG. 3b is a top view of the aerosolizing element, FIG. 3c is a bottom view of the aerosolizing element, FIG. 3d is a front view of the aerosolizing element, and FIG. 3e is a sectional view of the aerosolizing element, taken along line C-C in FIG. 3d, according to an exemplary embodiment of the present invention.

FIG. 4a shows an exploded view of the body assembly, FIG. 4b shows a front view of the body assembly, and FIG. 4c shows a sectional view of the body assembly taken along line D-D, according to an exemplary embodiment of the present invention.

FIG. 5a shows an exploded view of a mouthpiece module of the system, FIG. 5b shows a front view of the mouthpiece module, and FIG. 5c shows a sectional view of the mouthpiece module taken along line E-E in FIG. 5b, according to an exemplary embodiment of the present invention.

FIG. 6a shows front view of the system, FIG. 6b shows a sectional view taken along line B-B of FIG. 6a, and FIG. 6c shows an enlarged view of a portion C in FIG. 6b, according to an exemplary embodiment of the present invention.

FIG. 7 shows a sectional view of the mouthpiece and the airflow carrying the vapors through the mouthpiece, according to an exemplary embodiment of the present invention.

FIG. 8 shows an ultrasonic, piezo-electric element with a metal sheet at the center containing pores, according to an exemplary embodiment of the present invention.

FIG. 9 shows an electrical resistor element, according to an exemplary embodiment of the present invention.

FIG. 10 shows an induction element that has multiple air pockets, according to an exemplary embodiment of the present invention.

FIG. 11a shows a front view of an embodiment of the aerosolizing element; FIG. 11b shows a sectional view of the aerosolizing element taken along the section line F-F of FIG. 11a; and FIG. 11c shows an exploded view of the aerosolizing element, according to an exemplary embodiment of the present invention.

FIG. 12a shows an exploded view of another configuration of the aerosolizing element; FIG. 12b shows the front view of the aerosolizing element; and FIG. 12c shows a sectional view of the aerosolizing element taken along the section line F-F in FIG. 12b, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Although the structures and concepts of the device presented here focus on an embodiment involving induction heating, one may substitute the induction heating element with a piezoelectric element, a resistor heating element, or any other heating system without departing from the scope of the present invention.

Disclosed is a vaporizing system for substances, such as liquids, thick liquids, semi-solids, waxes, solid substances, and the like. The disclosed system primarily overcomes the leakage problems in conventional vaporizing devices. The system also avoids complex design by including fewer components.

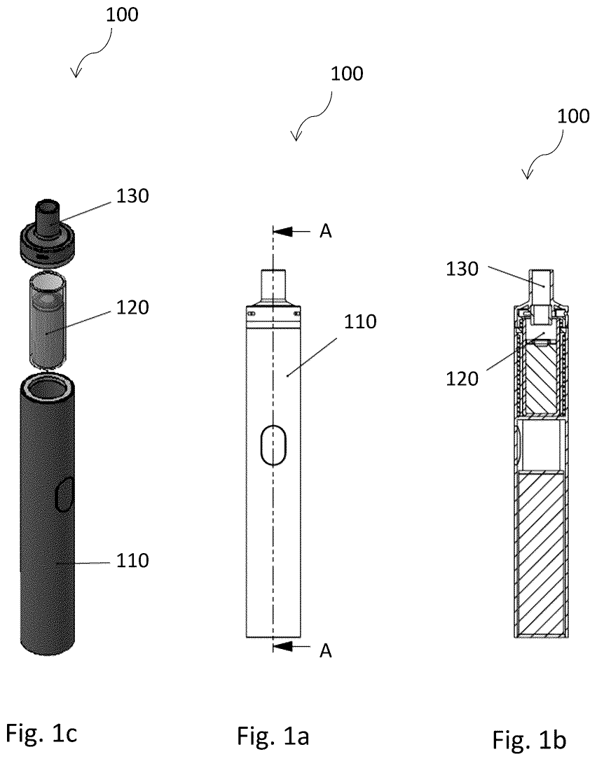

Referring to FIG. 1a, the disclosed system 100 includes a body assembly 110, a cartridge module 120, and a mouthpiece module 130. The body module encases the cartridge module, the cartridge module contains the active substance to be vaporized and an aerosolizing element for vaporizing the substance. The active substance can be in the form of liquid, thick liquid, semi-solid, wax, gel, and solid.

In one implementation, the aerosolizing element can be based on induction. The position of the aerosolizing element within a container of the cartridge module 120 can be varied. As shown in FIG. 1, the disclosed system may not use any wick to channel liquid from a container to the heating element. The absence of a wick makes the design simpler, and efficient and prevents leak problems.

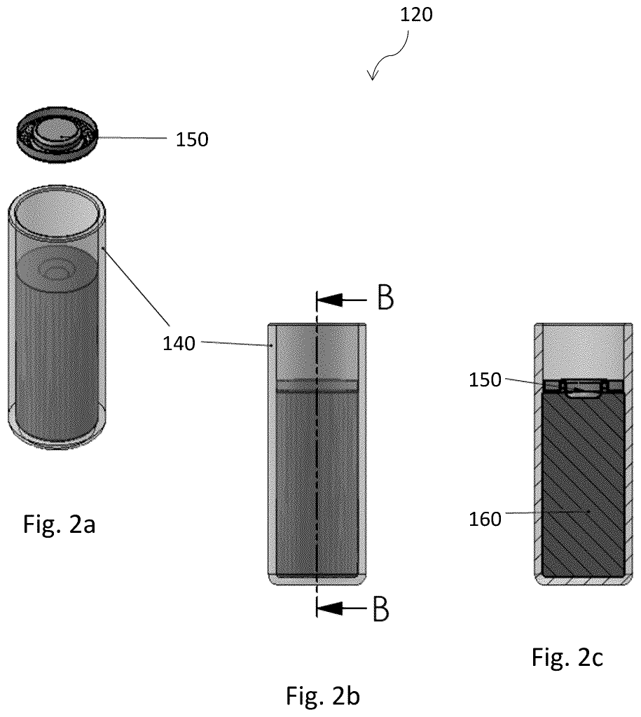

Referring to FIGS. 2a, 2b, and 2c which illustrate the cartridge module 120. The cartridge module may include a container 140 and an aerosolizing element 150. The drawings show the container having the active substance for vaporization, wherein the substance is in a liquid, thick liquid, or gel form. The aerosolizing element includes an inductive heating mechanism, and the container may be unaffected by the induction field. FIG. 2c shows the aerosolizing element placed over the active substance 160 in the container. The container has an open top while the rest of the container is fully solid. The aerosolizing element remains in contact with the top layers of the active substance due to adhesive forces. Also, when the liquid is a thick liquid or even a gel, the top layers of the active substance in the container get heated and liquefy or melt, becoming freer flowing before vaporization. The freer flowing portions can ensure a constant flow to the areas of the aerosolizing element where more heat is concentrated and becomes vaporized.

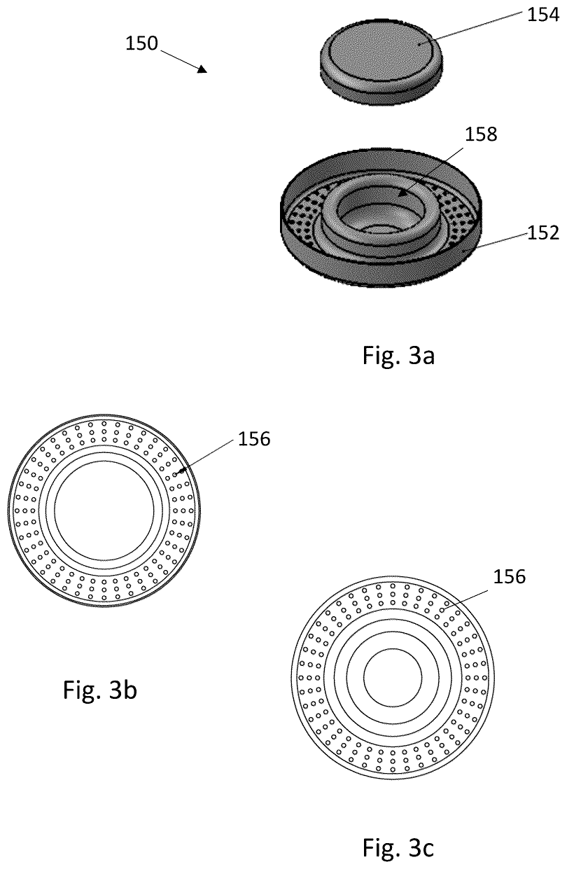

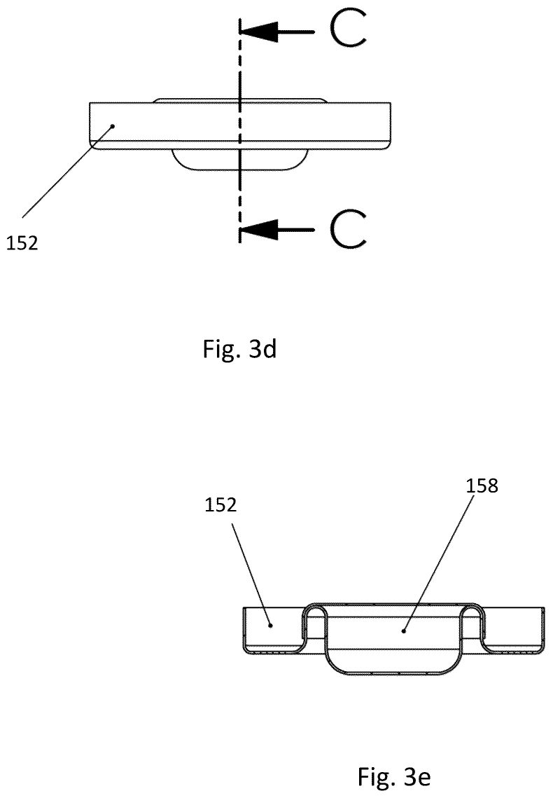

The aerosolizing element has both electrical conduction properties as well as magnetic properties (hysteresis) to facilitate heating via induction. The aerosolizing element can move vertically within the container freely and thus has a diameter less than the inner diameter of the container. The aerosolizing element can move vertically downwards with decreasing volume of the active substance in the container i.e., when the active substance is getting consumed. The aerosolizing element may virtually act as a cap of the container but not placed over the open top. The aerosolizing element can be heated through induction energy, however, any other means of heating, such as resistive heating are within the scope of the present invention. Moreover, other means for vaporization, such as piezoelectric atomization can be used for liquid/water-based active substances. The aerosolizing element, more clearly shown in FIGS. 3a-3c may have pores, openings, and/or through-holes through which vapors or aerosolized particles may escape. Since the aerosolizing element can freely travel within the container, there is sufficient space for liquid to move upward as a layer along the wall adjacent to the aerosolizing element, especially during heating. When the liquid moves up the perimeter wall of the aerosolizing element, it can also be vaporized and released into the air for inhalation. This mechanism may work in addition to the pores and openings on the aerosolizing element or simply by itself. It is to be understood that the active substance is shown for illustration only and the same may not be a part of the disclosed system, but the active substance can be filled into the container as and when required.

Thus, the aerosolizing element may act both as a heating element and also function as a cap to the container to prevent the liquid from spilling or leaking out. As the liquid level drops due to the vaporization of the liquid/gel, adhesive forces between the liquid and the heating element cause the heating element to travel downwards with the liquid level. Thus, the bottom surface(s) of the heating element shall maintain contact with the top surface of the liquid/gel, even if the system were to be held at an angle not optimal for gravity to pull the heating element and liquid/gel downwards.

The only risk of leakage in the aerosolizing element comes from any openings existing between the aerosolizing element and the container, or the openings on the aerosolizing element itself. Therefore, if the sizes of these openings are optimized such that the surface tension of the liquid/gel prevents the liquid from breaking through the openings, there will be no leakage. There is another benefit of the design: the opening of the container is located above the aerosolizing element, so that if the cartridge is positioned at or near an upright position, it would be physically impossible for the liquid to leak out, even under significant vibrational forces.

Furthermore, even when a liquid of relatively low viscosity is used, and the openings described above are small enough so that the surface tension of the liquid cannot be broken, then the liquid will not leak out upon inverting the container, because there is no way for air to pass through the barrier formed by the surface tension at the openings.

Referring to FIGS. 3a-3e, wherein FIG. 3a shows an exploded view of the aerosolizing element, FIG. 3b shows a top view thereof, FIG. 3c shows a bottom view thereof, FIG. 3d shows a front view thereof, and FIG. 3e shows a sectional view taken along line C-C in FIG. 3d. The aerosolizing element may include a base plate 152 and a top cap 154. The base plate 152 has multiple pores 156 and a central cavity 158. The base plate may be flat, and a skirt may extend upwards from the periphery of the flat plate. The base plate may be of a certain thickness or depth, or some extension in the vertical direction, i.e., the upstanding skirt, that may prevent the aerosolizing element from flipping over inside the liquid container. If the space between the aerosolizing element and the liquid container is controlled to be sufficiently small, for example, a few microns, then even a low viscosity liquid may not leak out when the container is flipped upside down or tilted at a severe angle. The pores may be small enough for the surface tension of the liquid to prevent air from leaking in through the pores. Furthermore, if the surface area between the outer side walls of the aerosolizing element and the inner walls of the container is big enough (i.e. there is a side wall of significant height, or the aerosolizing element has a considerable depth with a smooth, continuous side wall), liquid trapped in between may provide a suction force due to the surface tension and adhesion between the liquid/solid interfaces so that it forms a barrier preventing air to leak in, thereby preventing the liquid from leaking out even when the cartridge is upside down or held at a severe angle.

The central cavity 158 of the base plate may contain air that may allow the aerosolizing element to float. The central cavity can be sealed and closed by the cap 154. It is to be noted that any sealed air cavity can be incorporated without departing from the scope of the present invention. The side walls of the aerosolizing element lie in parallel with the inner wall of the container, which prevents any leakage from the peripheral gap and flipping of the aerosolizing element.

The aerosolizing element can be made of materials subjected to induction heating, whether by induced eddy current within the material or the oscillation of magnetic domains or magnetic dipole moments, and materials not subjected to induction heating, so that the combination of the two materials may be optimized to have specific zones to atomize the material in the container.

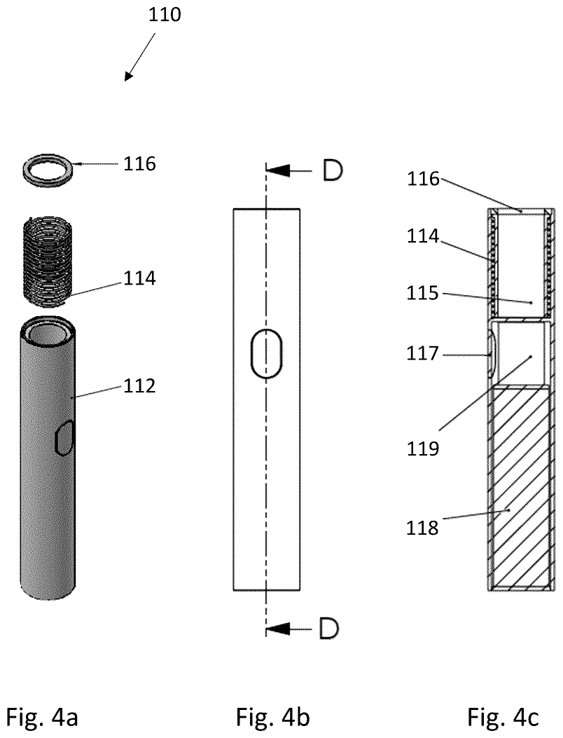

Referring to FIGS. 4a-4c, FIG. 4a shows an exploded view of the body assembly, FIG. 4b shows a front view thereof, and FIG. 4c shows a section view thereof taken along line D-D of FIG. 4b. The body assembly 110 includes a body 112 that forms a casing of the system and encases different component including the cartridge module. The body assembly also includes an induction coil 114 for inductive heating of the aerosolizing element. A magnetic ring 116 is also shown in the exploded view that can be coupled to an open top of the body. To the magnetic ring, the mouthpiece can be magnetically attached. It is understood, however, that the mouthpiece can be attached using any other fastening mechanism, such as snap-fit, friction-fit, threaded screw, and the like, and any such mechanism is within the scope of the present invention. The magnetic ring can be optional and replaced by any other fastening mechanism.

Again, referring to FIG. 4c, the body can be of a tubular elongated shape, thus the system may appear like a pen. However, any other shape of the body, and thus the disclosed system is within the scope of the present invention. A battery 118 for powering the induction coil and control circuitry 119 can be encased within the tubular body. The shape of the battery may depend upon the shape of the body. Moreover, the battery can be a disposable battery or a rechargeable battery. In the case of rechargeable batteries, suitable charging circuitry can also be provided. The charging circuitry may also support wireless charging, the technology of wireless charging is known in the art. Also, the induction coil may also be powered externally independent of the battery. As shown in FIG. 4c, the battery can be encased at the bottom of the body. The battery can be connected to the control circuitry also encased within the body and above the battery. The control circuitry can include all the electrical components for controlling and operating the system. A button 117 can be used to turn on and off the system, the button can protrude from the body and be connected to the control circuitry. The control circuitry may also be connected to other electrical components of the system, such as pressure sensors, thermocouples, electronic displays, and the like. The control circuitry may include suitable computational algorithms to calculate the electrical power supplied at the aerosolizing element, thus controlling the rate of atomization and/or temperature of atomization. The control circuitry may also include one or more thermocouples to sense ambient temperature to help compute the power required by the aerosolizing element to achieve a specific rate of atomization output (and/or output temperature). The display or other indicators may show various temperatures, functions, battery levels, etc. The buttons can be used to activate the atomizer, adjust power settings, adjust temperature settings, and control other functions on the system. Also, the system may include a Bluetooth® chip, RFID sensor technology, etc. on the circuit board to validate the cartridge and connect the device to cell phones and/or computers.

The induction coil is of a spring tubular shape with a diameter slightly less than the inner diameter of the body. A tubular spacer 115 may be used to secure the induction coil and is held within the induction coil. The tubular spacer can be made from materials that do not interfere with the inductive field and remain unaffected by the inductive field. The tubular spacer may also hold the cartridge module in place. Moreover, the magnetic ring can be attached to the tubular spacer.

The induction coil can provide inductive heating, wherein the induction coil can be connected to a control circuitry of the system. The drawings show one implementation of the inductor coil; however, any other variations of the inductor coil and capacitors are within the scope of the present invention. The inductor coil may achieve efficient heating at the skin depth of 0.01 mm. Note: regardless of skin depth, the alternating magnetic field within the induction coil acting upon the magnetic domains of a magnetic heating element may generate more heat than the effect of eddy currents traveling through the metal. Thus, a magnetic heating element may be a preferred choice. However, any other heating means are within the scope of the present invention. It is understood that the drawing shows only a possible arrangement of the components as an example, and any other arrangement of the components within the body assembly is within the scope of the present invention.

FIG. 4c shows one implementation of the induction coil being located near the top of the body with an opening at the top so that the cartridge can be inserted downward into the tubular spacer. This allows the construction of a pen-shaped system, where the circuit board and battery are positioned below the induction coil. The cartridge of this embodiment may contain a mouthpiece component connected to the container. Or, the cartridge module can serve as the replaceable cartridge, which can be connected to the mouthpiece component. There may be a click-to-lock mechanism or magnet(s) to secure and lock the mouthpiece to the body assembly. The main advantage of this embodiment may be its compactness.

In another implementation, the induction coil may be encased near the middle or bottom of the body. The induction coil may be located on a rotating door so that it can be rotated outward by about 90 degrees to insert the cartridge into the body. When the access is open, the cartridge may be inserted and secured when the rotating door is closed. The benefits of this implementation are as follows: no necessity of having a locking mechanism for the mouthpiece, which may reduce the cost per cartridge; the mouthpiece may be integrated with the body and may also contain other features such as a water filtration module that sits above the cartridge; the overall shape of the device can be of a box shape rather than a pen shape, or any other shape. Thus, by changing the position or arrangement of the induction coil, features can be added and removed, and the shape of the system can be modified, making the disclosed system more versatile.

Yet in another implementation, the induction coil can be located at the bottom of the body, and the bottom of the body can be capped, such as by a rotating or a sliding door (without the induction coil). The cap can be opened or detachably removed to access the bottom opening in the body for inserting the cartridge upwards into the induction coil chamber. Once inserted, the open bottom can be capped. The mouthpiece, as described above, may be integral and incorporate additional features.

The integral mouthpiece may only be optional, preferably, the mouthpiece may be removable so that it can be washed or cleaned easily. The mouthpiece may be on top of a water bubbler, or some other filtration system, which may or may not be attached to the mouthpiece or may be removably attached to the mouthpiece. This combination of the mouthpiece component with the filtration component may be positioned above the cartridge, or they may be connected to the cartridge in a way that allows the aerosolized particles to travel from the cartridge through the filtration system and mouthpiece.

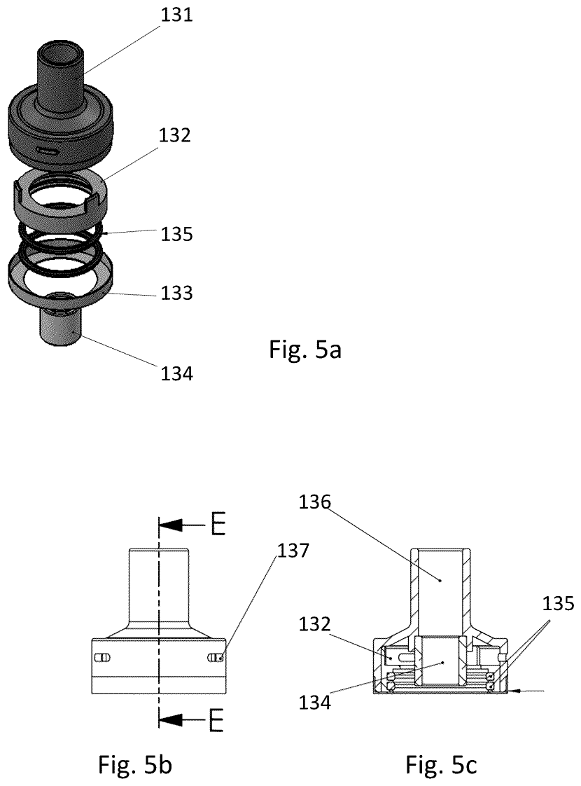

Referring to FIGS. 5a-5c, wherein FIG. 5a shows an exploded view of the mouthpiece module, FIG. 5b shows a front view of the mouthpiece module, and FIG. 5c shows a section view taken along line E-E of FIG. 5b. The mouthpiece module includes a mouthpiece 131, a mouthpiece upper ring 132, a mouthpiece lower ring 133, a ceramic heat shield 134, and rubber seals 135. The mouthpiece is through which the user can inhale the vaporized substance. The mouthpiece upper ring can house a silicone rubber seal that can hold onto the cartridge module through frictional force. The mouthpiece's lower ring may include an attachment member for attaching the mouthpiece to the body assembly. The mouthpiece's lower ring can be made from magnetic material for attaching the same to the magnetic ring of the body assembly. The ceramic heat shield can be made from ceramic or heat-resistant materials. The ceramic heat shield can be pressed onto the mouthpiece and serves as a heat shield against the vapors and heating element. The rubber can be inserted into the mouthpiece i.e., into the cavity underneath the mouthpiece into which the cartridge is inserted. The rubber seal can preferably be made of high-temperature heat-resistant material and can frictionally hold the cartridge in place. The mouthpiece includes a tube portion 136 that acts as an outlet port for air and a cylindrical base that includes an inlet opening 137 for air intake. The position of the inlet opening in the mouthpiece may be important for the airflow to carry the vapors.

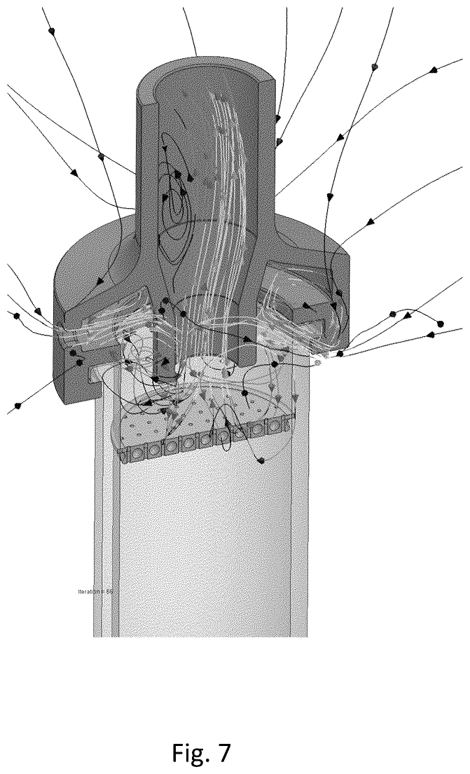

Referring to FIG. 7 which shows the air flow carrying the vapors through the mouthpiece. The mouthpiece is shown in a half cutout so that interiors may be visible. A hollow structure of the interior of the mouthpiece is shown and the flow of air is shown by arrows. The air may enter through the inlet upon suctional forces applied to the mouthpiece. The air flows horizontally above the liquid container and carries the vapors from the aerosolizing element. In the path of this air flow trajectory, the hollow structure extends slightly into the container, causing the airflow to bend around it. In this design, air flows horizontally, then downwards, and finally upwards through the air flow exit at the mouthpiece. Note that the hollow structure sits above the heating element without contacting it. Air shall flow in from the air inlets on the side walls of the mouthpiece module and travel through the spaces between the hollow structure and the liquid container. Thus, the air will eventually travel downwards and make a turn to flow upwards through the mouthpiece. Air may follow some spiral trajectory starting from the outer perimeter of the hollow structure into the interior of the hollow structure. When air makes a turn inside the liquid container and above the heating element, there may be a pressure gradient that may allow the aerosolized particulates to travel upwards. Without limiting the invention by the design of the airflow pathway, the aforementioned design is just one possible exemplary embodiment. Other embodiments may be preferable for different exterior designs of the system. For example, a hollow tube extending into the liquid container may function as the air inlet rather than an air outlet, and the hollow space encapsulating the container may have an opening that is connected to the mouthpiece located somewhere else and not directly up.

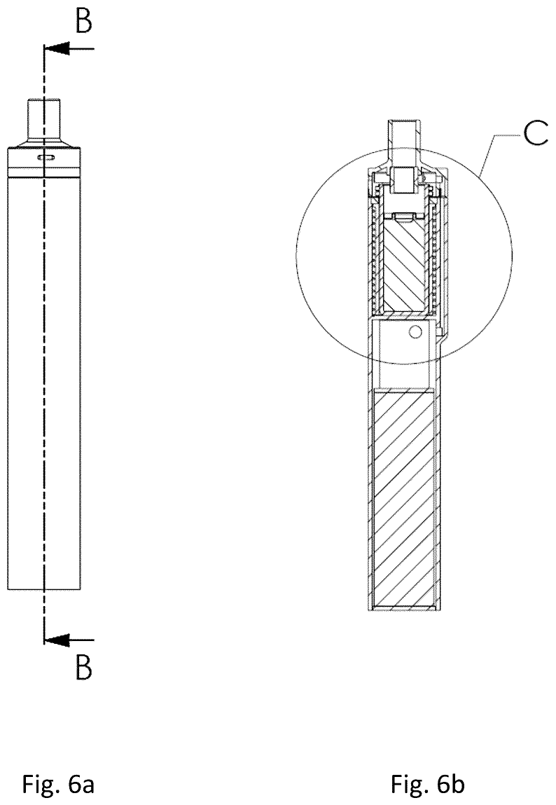

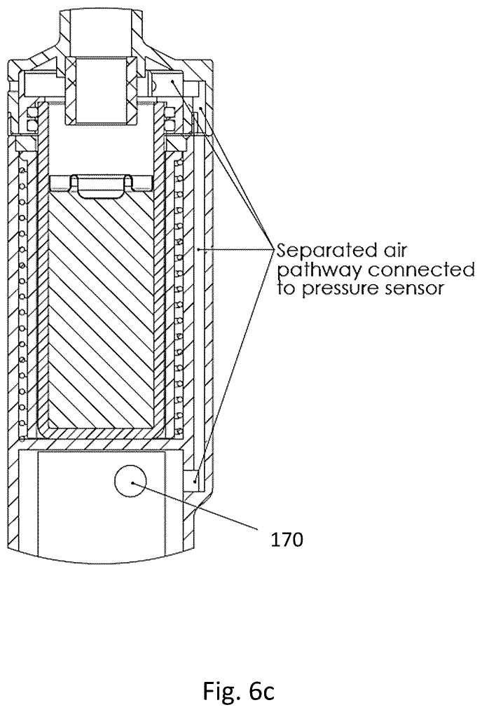

Referring to FIGS. 6a-6c, which illustrates the use of pressure sensors. An air pressure sensor 170 that is fluidly connected to the mouthpiece, can be used to activate, and deactivate the atomization by sending signals to the control circuitry.

The airflow of the novel induction cartridge system may be different from most conventional cartridge systems. Conventional cartridge systems usually have an airflow path that goes through the liquid container. This is usually achieved by having a tubular structure separating the liquid and the air. The heating element is placed within the air path of such airflow structure so that vaporized particulates are carried outwards. For electronic cigarette applications, such designs may work well. However, for more viscous liquids employed in the cannabis industry (oil, distillate, wax, resin, etc.) the vaporized particulates may quickly condense in the air path and form blockages to clog the air path. Besides making the device not function properly, this is potentially a choking hazard as well as creating a risk of inhaling larger chunks of material into the lungs.

The cartridge in this novel invention seeks to avoid the above issues by utilizing (but not limited by) a horizontal component in the air flow pathway above the opening of the liquid container, which creates a pressure drop that carries vaporized particulates from below and inside the liquid container upwards. This is like how a chimney works to remove smoke from a fireplace. The airflow pathway shall have ample space to prevent the build-up of condensed particulates from interfering with the flow of air during use, of which the narrow airflow tubes of conventional cartridges frequently encounter.

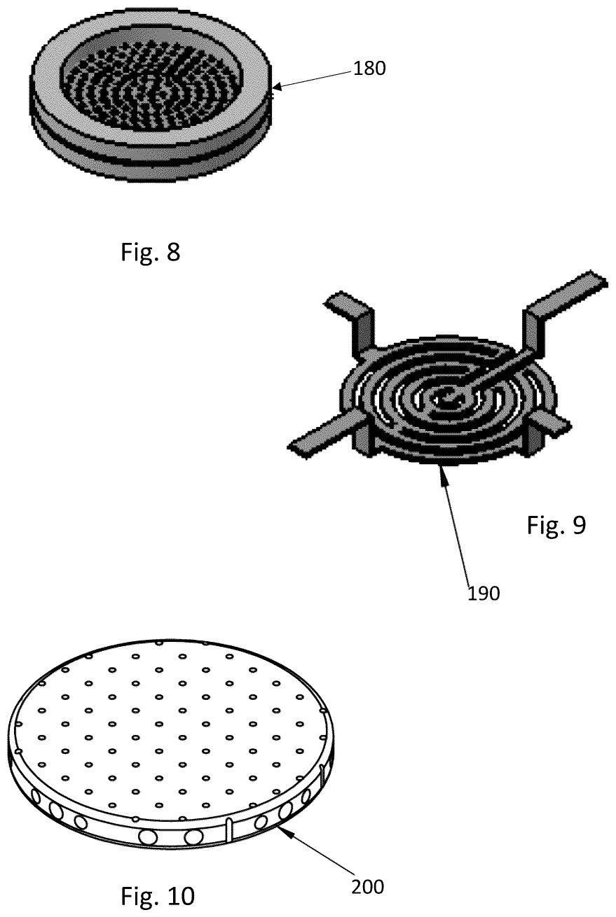

Referring to FIGS. 8-10, which show an alternate embodiment of the aerosolizing element. FIG. 8 shows an ultrasonic, piezo-electric element 180 with a metal sheet at the center containing pores. Such an aerosolizing element can be used for liquid substances, such as solutions, extracts, and the like. The piezo-electric element can include a float component that allows it to float over the liquid substance in the container and remain in contact with a top layer of the liquid. The piezo-electric element can be powered through an in-built battery or wirelessly through the outside. For example, the piezo-electric element can be powered by the induction coil. In one implementation, the piezoelectric element (for example, a vibrating disk with through holes) is electrically connected via drop-down wires inside the container to electrical contacts located on the exterior of the cartridge, which is to be connected to the control circuitry when the cartridge is inserted into the body.

FIG. 9 shows an electrical resistor element 190 that can be manufactured from sheet metal with relatively tight spaces. The electrical resistor element can include a floating component that allows it to float over the liquid substance in the container and remain in contact with a top layer of the liquid. The electrical resistor element can be powered through an in-built battery or wirelessly through the outside. For example, the electrical resistor element can be powered by the induction coil.

FIG. 10 shows an alternate embodiment of the induction element 200 that has multiple air pockets. The induction element may consist of a solid body that has a sufficient thickness, which prevents it from flipping or tipping over inside the container.

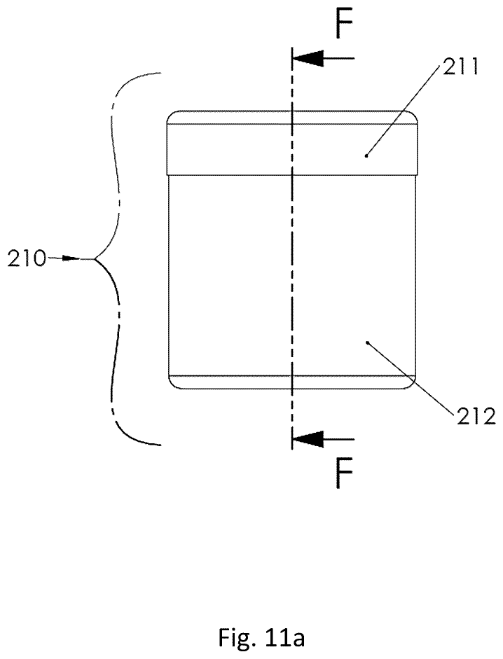

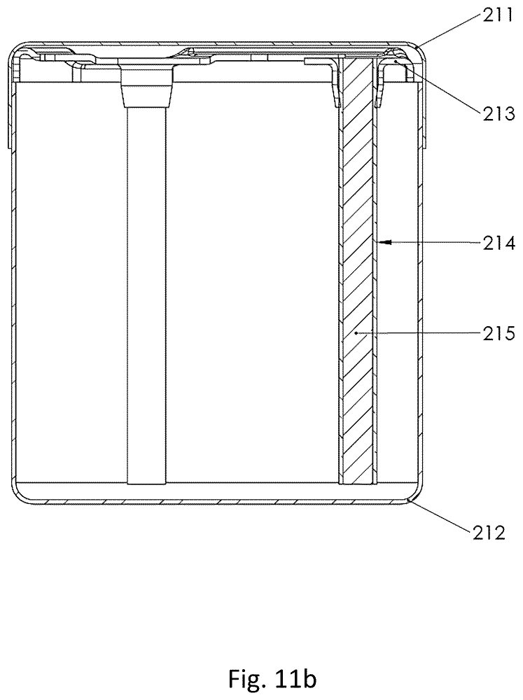

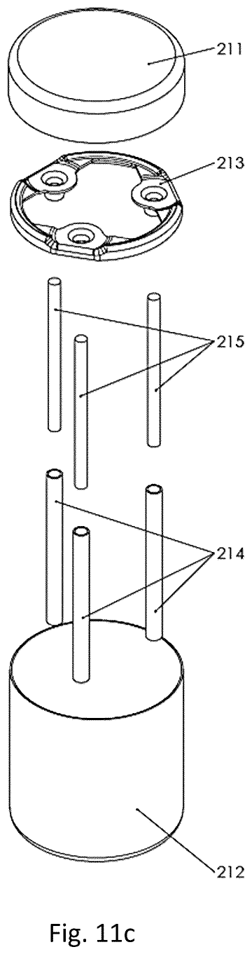

Now referring to FIGS. 11a-11c, wherein FIG. 11a shows a front view of an embodiment of the aerosolizing element 210, FIG. 11b shows a sectional view, and FIG. 11c shows an exploded view of the aerosolizing element 210. This embodiment comprises a capsule structure that encloses a cavity, which is formed by the coupling of a thin-walled cup 212 and cap 211, both made from SS316 or similar material, with wall thicknesses between 0.05 mm and 0.20 mm. There are other ways to form the capsule structure, such as having a tube instead of the cup 212 and the tube is coupled to two caps 211 on either end. The exploded view of FIG. 11c further shows the interior components positioned inside the capsule structure. There is a heat-sink structure, which in this embodiment comprises a ring structure 213 coupled to three hollow tube structures 214. The heat-sink structure is coupled to the capsule structure and contacts the interior, rounded edge of the cap 211 and the top edge of the cup 212, which can be seen in FIG. 11b. The heat-sink structure may be made from a material with a thermal conductivity of 100 W/mK or greater. Good material candidates include copper and beryllium copper to name a few.

In this embodiment, coupled to the heat-sink structure are three workpiece structures 215 that extends substantially inside the cavity. The material of the workpiece structures 215 may be iron or any other ferrous material. In this embodiment, the workpiece structures 215 are cylindrical in shape and have lengths of about 10 mm and diameter of about 0.7 mm. The workpiece structures 215 can be in other shapes, forms, and also differ in number. For example, instead of three rods it can be a single rod. Instead of being cylindrical rods it can be a flat shape. However, the flat portion needs to be at least 0.1 mm in thickness for the workpiece structure to generate sufficient heat under an alternating magnetic field between 40,000 Hertz and 100,000 Hertz. The workpiece structure can also comprise a hollow tube having sufficient thickness. Having mentioned the above alternative configurations of the workpiece structure 215, the inventor of this invention has presently found that the configuration of this embodiment to be sufficiently optimal.

In this embodiment, the workpiece structures 215 are coupled to the heat sink structure by being positioned inside the three hollow tube structures 214, which in this embodiment has a thickness of about 0.1 mm. The hollow tube structures 214 can be made from a sheet material wrapped around the workpiece structures 215, or it can simply be a coating or a plating on the workpiece structure with sufficient thickness. It can also be a sheath covering, surrounding, and contacting the workpiece structure 215. The heat-sink structure does not have to include the ring-structure 213. For example, one skilled in the art can easily envision one or more workpiece structure 215 in the shape of a wire bent at 90 degrees, such that it has a horizontal segment transitioning to a vertical segment. In this case, the heat-sink structure may comprise only the hollow tube structure 214 covering the bent wire, so that the hollow tube structure would have the same bend as the wire. The horizontal portion of the hollow tube structure 214 may be coupled to the cap 211 of the capsule structure through perhaps laser-welding. The working mechanisms would be identical except the heat-sink structure would be comprised of one less component.

In this embodiment, the workpiece structures are spaced about 5-6 mm away from each other and at 120 degrees from each other about the central axis of the cup 212. At these distances and angular position, the workpiece structures 215 are spaced far apart enough not to negatively interfere with each other in the presence of an external, alternating magnetic field with field lines parallel to the cylindrical axis of the workpiece structures. The negative interference arises from each cylindrical rod of workpiece structure 215 generating its own magnetic field when the magnetic domain aligns with the external magnetic field. It is important to also note that the most optimal orientation of the workpiece structure is aligning its cylindrical axis in parallel with the magnetic field lines.

The aerosolizing element of FIG. 11 a-FIG. 11 c works by way of induction heating. The three workpiece structures 215 rapidly heat up under a magnetic field at an alternating frequency between 40,000 Hertz and 100,000 Hertz, which can be supplied by the induction work coil located on the device. The voltage supplied can be anywhere between 5-10V and the power of the three workpiece structures 215 can reach over 50 W provided sufficient current output from a power source. For example, an LCR circuit operating at 80% efficiency at 8V and 7 Amperes can supply about 45 W of power to the workpiece structures 215 in the current, disclosed configuration. Heat from the workpiece structures 215 are rapidly extracted away via conduction by the heat-sink structure 213 & 214 coupled to them. Much of the heat from the workpiece structures 215 is transferred to the corner and top portions of the cap 211 through the heat-sink structure. Depending on the material used for the ring-structure 213, over 50 percent of the heat from the workpiece structures 215 can be transferred to the cap 211. The rest of the heat is transferred to all surfaces of the capsule structure by means of convection and radiation. It is important to note that in this embodiment the three workpiece structures 215 do not directly contact the capsule structure. This is so that the heat can be efficiently conducted to the upper corner of the cap 211 via the heat-sink structure. Otherwise, there may be hot spots on and near any point of direct contact between the workpiece structure 215 and the capsule structure.

Provided that the heat-sink structure makes sufficient contact with the capsule structure, and more specifically in this embodiment the ring structure 213 makes sufficient contact with the cap 211, at 40 W of power on the workpiece structures 215, the rounded edge of the cap 211 can reach 175° C. in less than 2 seconds starting from room temperature while the aerosolizing element 210 contacts a liquid. The bottom surface of the cup 212 is slowest to heat up and may take about 10 seconds to rise by 30° C. The thermal gradient of the aerosolizing element 210 is therefore characterized by having a high temperature at the top of the capsule structure, primarily on the surfaces of the cap 211. The lowest temperature will be at the bottom surface of the cup 212. The cup 212 and cap 211 may be press-fitted or welded together and may be airtight. The heat sink-structure may also be welded onto the capsule structure to sustain sufficient contact between the two.

If the cup 212 and cap 211 are press-fitted together but does not form an airtight cavity inside, the cap 211 may comprise one or more small holes on the top of about 0.15 mm in diameter. This is because the pressure built-up inside the capsule structure can roughly double the atmospheric pressure during heating; when the aerosolizing element 210 cools down after heating, some liquids of relatively low viscosity can be sucked into the cavity from any small opening located at and between the location of overlap of the cup 212 and cap 211. Having a small hole at the center-top of the cap 211 would allow air to enter into and exit from the cavity thereby creating a state of equilibrium between the pressure inside the capsule structure and outside. In the absence of a negative pressure gradient within the capsule structure as the aerosolizing element 210 cools down, liquid will likely not be sucked into the cavity.

It is important to note that the primary mechanism of induction heating on the aerosolizing element 210 is by way of flipping the magnetic domains of the workpiece structures 215. There is minimal heating directly by the alternating magnetic field, if at all, on the cap 211, the cup 212, the three hollow tube structures 214, and the ring-structure 213. In other words, at the frequencies between 40,000 Hertz and 100,000 Hertz, it is observed that the induction field primarily only heats up the workpiece structures 215 and not the other components. The other components rise in temperature partially due to the heat conducted from the workpiece structures 215, and partially due to convection and radiation inside the aerosolizing element 210 with the workpiece structures 215 functioning as the primary heat source.

The aerosolizing element 210 of FIG. 11a-FIG. 11c is effective for aerosolizing a highly viscous liquid or a wax material, such as the various types of concentrates derived from the cannabis plant. When a concentrate contacting the bottom surface of the capsule structure melts due to the heat generated, the melted liquid will travel upwards along the perimeter wall of the aerosolizing element 210. As it moves upwards, it will reach the hottest region at the top corner of the cap 211, where it will be vaporized. This embodiment of the aerosolizing element 210 comprises of a single, large air cavity, and together with the mass and shape of the aerosolizing element 210, the aerosolizing element 210 is configured to float in the melted material. Liquid expands and decreases in density when it is heated. Therefore, the aerosolizing element 210 is configured to be able to float in a liquid having a density of not less than 0.5 g/cm³.

The aerosolizing element 210 comprises both ferrous and nonferrous materials optimized to melt an active substance in incremental amounts while vaporizing and depleting the active substance. As mentioned previously, the melted amount will travel upwards along the perimeter wall of the aerosolizing element 210 and be vaporized once it reaches the top of the aerosolizing element 210. This embodiment is especially useful for cannabis-based concentrates where excessive heat can damage the flavor profile of the concentrate. This aerosolizing element 210 has the capability to melt the material in the immediate vicinity below the exterior, bottom surface of the cup 212 where the temperature increase is minimal. The melted material travels within the peripheral gap between the exterior surface of the aerosolizing element 210 and the interior surface of a container (holding the aerosolizing element 210 positioned above the material) and makes its way to the top of the aerosolizing element 210 due to the adhesive force between the liquid and solid surfaces. The high temperature of the cap 211 then vaporizes the material. This is all achieved without any intermediary wicking material. Thus, this embodiment of the aerosolizing element 210 is an ideal implementation of the present invention for cannabis concentrates.

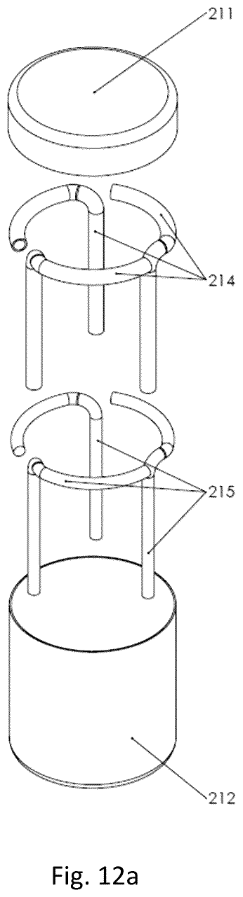

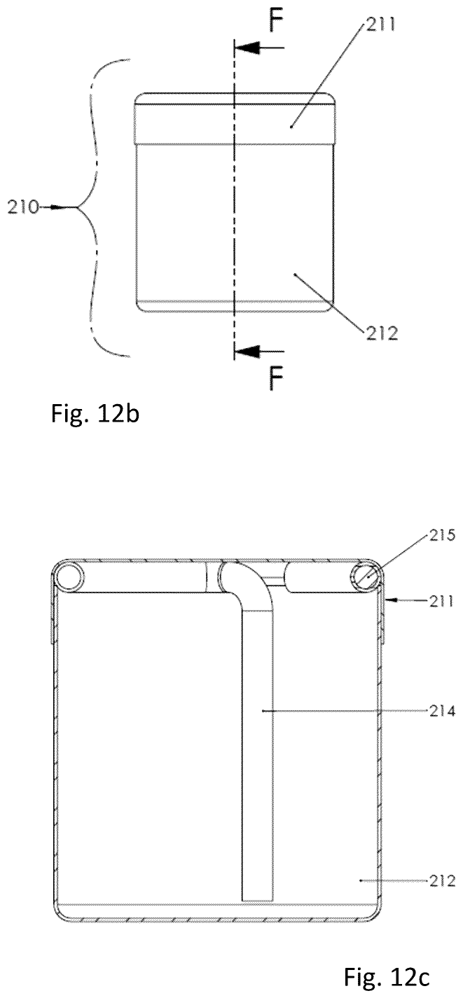

FIGS. 12a-12c show an alternative embodiment of the aerosolizing element 210. The main differences are as follows: the workpiece structure 215 has a different shape; the heat-sink structure no longer comprises the ring structure 213 of FIG. 11a-11c but only consists of the hollow tube structures 214, which are coupled to the cap 211 perhaps by means of laser welding. The working principles and mechanisms are the same as those described previously for FIG. 11 otherwise. One who is skilled in the art can easily see that the workpiece structure 215 can be directly coupled to the capsule structure (in this case, the upper round corner of the cap 211) without the heat sink structure (in this case the hollow tube structures 214) perhaps by means of laser welding. However, without the heat sink structure, the aerosolizing element will have more significant hot spots during operation.

It is to be noted that more than one aerosolizing mechanism can be incorporated into the disclosed system, and any such combination of aerosolizing mechanisms is within the scope of the present invention.

In certain implementations, the cartridge module may be replaceable, disposable, or refillable. The container of the cartridge module may be compatible with inductive heating and does not generate heat under electromagnetic induction. The container may also be made from material that is heat resistant and compatible with the active substances. Also, the material of the container may not leach or contaminate the active substances.

In certain implementations, the cartridge module and the mouthpiece module may be integral, and the combination can be replaced when desired, such as when the active container becomes empty and replaced by a new cartridge.

In certain implementations, the mouthpiece module may instead be thought of as an airflow structure containing one or more fluidly connected air inlets, air outlets, and hollow cavities. It can be an implementation of the mouthpiece module without a mouthpiece. Furthermore, a mouthpiece may be removably attached to an air outlet of the airflow structure so that users can inhale directly through the mouthpiece. Or a flexible tube may be connected to or be an integral part of the air outlet of the airflow structure instead, and the flexible tube can be configured to attach to any conventional water bubbler on the market. In this way, users can have the option of using an external water bubbler to inhale an active substance from the device.

In certain implementations, the aforementioned embodiments of the airflow structure may be configured to fluidly connect to the cartridge, the cartridge as described above including the container, the aerosolizing element, and the active substance. The cartridge may be removably and partially attachable to the airflow structure via frictional forces between the container and the rubber seals located on the mouthpiece module, which is now the airflow structure. The induction coil chamber located on the device body partially receives the cartridge when the airflow structure is connected to the device body.

In certain implementations, the cartridge may have cavities or protrusions to allow it to click in place when inserted into the body, where the body has corresponding protrusions or cavities designed to hold the cartridge in place. Also, a spring-loaded lock that clicks into place when the cartridge is inserted can be incorporated. Also, the cartridge may lock into place using a rotational locking mechanism (i.e., insert the cartridge, then rotate it to lock it into place). Also, magnets can be used to secure the cartridge within the body or tubular spacer, as the case may be.

The disclosed system can be advantageous in that it employs a unique cartridge system in which the aerosolizing element functions as a vertically movable lid that also seals off the material inside the container. As the material (usually a liquid or a gel) is being used up, the movable lid/aerosolizing element travels with the liquid line and maintains contact with it. The chief implementation of this idea is to utilize an induction coil configured to receive the cartridge. The major benefit of this system is that it simplifies the vaporizer cartridge into fewer components, thus reducing complexity and cost. This cartridge also does not use any wicks or intermediary material to transport the liquid to the heating element, thus reducing the risk of melting, burning, and inhaling the intermediary materials (usually cotton, fiberglass, plastic fibers, porous ceramics, etc.). Another important benefit is that the cartridge of the disclosed system is especially compatible with thick liquids or gels like wax, resin, crystals, or other inhalable materials derived from cannabis plants. Thick materials cannot be made to flow easily like a liquid, so traditional vaporizer systems do not work well.

In certain implementations, the aerosolizing element takes on a bowl shape, flat shape, wavey shape, or a combination of such shapes to allow it to float or sit on top of the liquid or gel.

In certain implementations, the aerosolizing element consists of a mesh structure attached to a floatation structure.

In certain implementations, the system may have an RFID chip so that when it is connected to the device, the device can validate the authenticity of the cartridge.

In certain implementations, a gyro sensor is placed inside the device to sense the angle of orientation or the “tilt” from the vertical, upright position of the device. When the device is oriented past a certain angle from the vertical, say 90 degrees, the gyro sensor can be used by the controller located on the circuit board of the device to cut off power to the aerosolizing element. This may help to prevent possible, unwanted leakage from the cartridge when users inhale from the device when the device is placed upside down.

In certain implementations, the aerosolizing element is designed to not flip over inside the container. Minimally speaking, if the height of the aerosolizing element is greater than the largest inner width of the container, it will be impossible for it to flip over. For example, one implementation is to make the aerosolizing element 11 mm high and the inner diameter of the container 10 mm wide. This configuration will prohibit the aerosolizing element from flipping over inside the container. Also more generally, if the length from the top corner to a lower opposite corner of the aerosolizing element is greater than the inner diameter of the container (if it is round), it will be impossible for the aerosolizing element to flip over. This length is dependent on the height and width of the aerosolizing element, so the higher it is the longer the length becomes. For example, if the top corner of the aerosolizing element is 11 mm from the opposite lower corner and the inner diameter of the container is 10 mm, it would be impossible for the aerosolizing element to flip over inside the container. There is an infinite number of right triangles restricted by the condition of having a hypotenuse greater than 10 mm and a side length less than 10 mm, and thus there exists an equal number of possible combinations of widths and heights of aerosolizing elements that can simultaneously slide up and down within the container while not being able to flip over inside.

In certain implementations, the cartridge can be implemented to be integral to the device body and cannot be normally removed or separated from the body. In such an implementation, the container of the cartridge may then contain a containing volume that is open at the top located accessible on the device body itself. The aerosolizing element, comprising at least a few of the important features aforementioned, can be a removable part placed inside the containing volume. The users of this device apparatus can then refill the containing volume with an active substance by themselves instead of purchasing prefilled cartridges. This is done by removing the aerosolizing element from the said containing volume, loading the containing volume with an active substance, and installing the aerosolizing element into the containing volume so that it sits on top of the active substance.

Furthermore, and in certain implementations, an airflow structure, which may comprise at least one air inlet and at least one air outlet mentioned previously, may further attach to the device body, and be fluidly connected to the containing volume of the device body to extract the aerosolized active substance. If the airflow structure were to comprise also a mouthpiece that is connected to the air outlet or encompasses the air outlet, then users can directly inhale from the mouthpiece when using the device.

Furthermore, and in certain implementations, the airflow structure may also comprise an extension tube fluidly and removably connected to the air outlet, where the extension tube can be connected to a conventional water bubbler. In this configuration, users may further attach the device fluidly to a conventional water bubbler for inhaling the active substance.

In another implementation, the airflow structure may further comprise at least one hollow cavity fluidly connected to the air inlet and air outlet, whereby the hollow cavity may further comprise an opening to be fluidly connected to the containing volume of the device body.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A cartridge comprising:
a container configured for containing an active substance; and
an aerosolizing element configured to be received within the container, wherein the container comprises:
at least one opening in a wall or top of the container, the at least opening is positioned above the aerosolizing element,
at least one inner wall parallel to a longitudinal axis of the container wherein the aerosolizing element is configured to freely slide within the container along the longitudinal axis of the container,
wherein the aerosolizing element comprises:
at least one side wall configured to remain relatively parallel to the longitudinal axis of the container, wherein the at least one side wall is of a sufficient height such that to prohibit the aerosolizing element from turning over inside the container.

2. The cartridge according to claim 1, whereas the cartridge further comprises:
an airflow structure comprising:
at least one air outlet and at least one air inlet, and the airflow structure further comprises:
a hollow region that fluidly connects the at least one air outlet, the at least one air inlet, and the at least one opening in the container.

3. The cartridge according to claim 1, wherein the at least one opening of the container is in the wall of the container and positioned nearby the top of the container.

4. The cartridge according to claim 1, wherein the aerosolizing element is configured to be in contact with the active substance contained in the container and move downwards with changes in a level of the active substance.

5. The cartridge according to claim 1, wherein the aerosolizing element further comprises:
at least one opening to allow for the active substance in an aerosolized form to escape, wherein the at least one opening in the aerosolizing element is of a circular shape or a slit shape.

6. The cartridge according to claim 1, wherein the aerosolizing element comprises at least one mesh structure.

7. The cartridge according to claim 1, wherein the aerosolizing element further comprises:
at least one air cavity, whereas at least one air cavity is configured to enable the aerosolizing element to float over the active substance when the active substance is in a liquid state.

8. The cartridge according to claim 1, wherein the aerosolizing element further comprises:
a piezoelectric element, whereas the piezoelectric element aerosolizes the active substance using ultrasonic waves.

9. The cartridge according to claim 1, wherein the aerosolizing element further comprises:
an electrical resistor, whereas the electrical resistor vaporizes the active substance through electrical heating.

10. The cartridge according to claim 1, wherein the aerosolizing element further comprises:
a plurality of pores, whereas the plurality of pores allows for aerosolized particles or vapors to pass through.

11. The cartridge according to claim 1, wherein the cartridge further comprises:
the active substance contained in the container, wherein the active substance is in a form of a gel, semi-solid, paste, or solid state at room temperature, and the aerosolizing element is configured to liquify at least a layer of the active substance in contact with the aerosolizing element through heating.

12. The cartridge according to claim 1, where the cartridge further comprises:
the active substance contained in the container, wherein the active substance is in liquid form at room temperature.

13. The cartridge according to claim 1, wherein the at least one side wall of the aerosolizing element and the at least one inner wall of the container are further configured to form a peripheral gap around the aerosolizing element.

14. The cartridge according to claim 13, wherein the aerosolizing element is configured to float over the active substance in the container, wherein the peripheral gap is configured to draw and be filled with the active substance in a liquid state, through adhesive forces existing between contacting surfaces of a liquid and solid, wherein the drawn active substance is further configured to act as a barrier preventing a bulk of the active substance stored below the aerosolizing element from leaking out of the container.

15. The cartridge according to claim 1, wherein the aerosolizing element is configured to be powered by an induction field.

16. The cartridge according to claim 15, wherein the aerosolizing element is powered by an induction field by further converting electromagnetic energy of the induction field into heat, which vaporizes the active substance.

17. The cartridge according to claim 16, wherein the aerosolizing element comprises at least one ferrous material.

18. The cartridge according to claim 15, wherein the aerosolizing element further comprises at least one nonferrous material.

19. An apparatus comprising:
a cartridge comprising:
a container configured for containing an active substance; and
an aerosolizing element configured to be received within the container, wherein the container comprises:
at least one opening in a wall or top of the container, the at least one opening is positioned above the aerosolizing element,
at least one inner wall parallel to a longitudinal axis of the container wherein the aerosolizing element is configured to freely slide within the container along the longitudinal axis of the container,
wherein the aerosolizing element comprises:
at least one side wall configured to remain relatively parallel to the longitudinal axis of the container, wherein the at least one side wall is of a sufficient height such that to prohibit the aerosolizing element from turning over inside the container;
a body assembly comprising an accessible cavity region to receive the cartridge at least partially; and
an airflow structure removably attachable to the body assembly, whereas the airflow structure comprises:
at least one first opening for airflow to enter the airflow structure,
at least one second opening for air to exit the airflow structure, and
at least one hollow cavity.

20. The apparatus according to claim 19, where at least one hollow cavity of the airflow structure has an opening, the opening is configured to removably receive a portion of the cartridge into the airflow structure.

21. The apparatus according to claim 19, wherein the at least one first opening and the at least one second opening are configured to fluidly connect to the aerosolizing element of the cartridge.

22. The apparatus according to claim 19, whereas the body assembly further comprises:
an induction work coil at least partially surrounding the accessible cavity region, whereas the induction work coil is configured to supply power wirelessly to the cartridge;
a compartment for holding a power supply, whereas the power supply provides electrical energy for operating the apparatus; and
and at least one circuit board electrically connected to the induction work coil and the power supply.

23. The apparatus according to claim 19, whereas the body assembly further comprises a gyro sensor, whereas the gyro sensor is configured to sense an orientation of the apparatus.

24. The apparatus according to claim 19, whereas the body assembly further comprises at least one temperature sensor, the at least one temperature sensor is configured to help determine an amount of power to be supplied to the cartridge.

25. The apparatus according to claim 19, where the airflow structure further comprises a mouthpiece.

26. The apparatus according to claim 19, where the airflow structure is further configured to lock onto the body assembly by a twisting motion.

27. The apparatus according to claim 19, where the airflow structure is further configured to attach to the body assembly through magnetic force.

28. The apparatus according to claim 19, where the airflow structure is further configured to attach to the body assembly by frictional force.

29. The apparatus according to claim 19, wherein the aerosolizing element is configured to be in contact with the active substance contained in the container and move downwards with changes in a level of the active substance.

30. The apparatus according to claim 19, wherein the aerosolizing element comprises at least one air cavity, whereas the at least one air cavity is configured to enable the aerosolizing element to float over the active substance in a liquid state.

31. The apparatus according to claim 19, wherein the at least one side wall of the aerosolizing element and the at least one inner wall of the container are configured to form a peripheral gap around the aerosolizing element.

32. The apparatus according to claim 31, where the active substance is configured to be stored below the aerosolizing element, and the peripheral gap is further configured to draw and be filled with the active substance, when the active substance is in a liquid state, through an adhesive force existing between contacting surfaces of a liquid and solid, wherein the drawn active substance is further configured to act as a barrier preventing a bulk of the active substance stored below the aerosolizing element from leaking out of the container.

33. A device for vaporization and/or atomization of an active substance, the device comprising:
a body assembly, the body assembly comprising:
a containing volume that is open at a top and has at least one inner wall parallel to a longitudinal axis of the containing volume;
an aerosolizing element configured to freely slide within the containing volume along the longitudinal axis of the containing volume, wherein the aerosolizing element comprises:
at least one side wall configured to remain relatively parallel to the at least one inner wall of containing volume, and the at least one side wall is configured to have sufficient height to prohibit the aerosolizing element from turning over inside the containing volume, and at least one air cavity configured to enable the aerosolizing element to float above the active substance in its liquid state;
an induction work coil configured to be at least partially surrounding the containing volume;
at least one circuit board electrically connected to the induction work coil;
a compartment for holding a power supply; and
an airflow structure configured to removably connect with the body assembly, whereas the airflow structure comprises:
at least one air inlet,
at least one air outlet, whereas the at least one air outlet is configured to fluidly connect to the at least one air inlet and the containing volume of the body assembly when the airflow structure is connected to the body assembly.

34. The device according to claim 33, wherein the aerosolizing element is configured to be in contact with the active substance and moves downwards with changes in level of the active substance when the active substance is loaded into the containing volume.

35. The device according to claim 33, wherein the aerosolizing element is configured to be powered by the induction work coil of the body assembly.

36. The device according to claim 33, where the airflow structure further comprises a mouthpiece.

37. The device according to claim 33, where the airflow structure further comprises:
at least one hollow cavity, whereas the at least one hollow cavity is further configured to fluidly connect to the at least one air inlet, the at least one air outlet, and the containing volume of the body assembly when the airflow structure is connected to the body assembly.

38. The device according to claim 33, wherein the aerosolizing element comprises at least one ferrous material.

39. The device according to claim 33, wherein the aerosolizing element comprises at least one nonferrous material.

40. An aerosolizing element for the vaporization and/or atomization of an active substance, the aerosolizing element comprising:
a capsule structure that at least partially encloses a cavity,
at least one workpiece structure extending at least partially into the cavity, whereby the at least one workpiece structure is coupled to the capsule structure and comprises a ferrous material that can generate heat under an alternating magnetic field, and the shape capsule structure, the mass of the aerosolizing element, and the volume of the cavity are configured such that the aerosolizing element can float in a liquid having a density of at least 0.5 g/cm³.

41. The aerosolizing element according to claim 40, where the capsule structure is comprised of a cap and a cup, where the cap and cup are coupled together to at least partially enclose the cavity.

42. The aerosolizing element according to claim 40, where the capsule structure is comprised of a tube and two caps, where the tube and two caps are coupled together to enclose the cavity at least partially.

43. The aerosolizing element according to claim 40, where the capsule structure comprises a nonferrous material.

44. The aerosolizing element according to claim 40, where the capsule structure comprises at least one hole at the top, where the at least one hole fluidly connects the cavity to the environment exterior to the capsule structure.

45. The aerosolizing element according to claim 40, where at least a portion of the at least one workpiece structure is in a cylindrical shape.

46. The aerosolizing element according to claim 40, where at least a portion of the at least one workpiece structure has a thickness of at least 0.1 mm.

47. The aerosolizing element according to claim 40, where the aerosolizing element further comprises at least one heat-sink structure that is coupled to the capsule structure, and the at least one workpiece structure is coupled to the heat-sink structure.

48. The aerosolizing element according to claim 47, where the at least one heat-sink structure comprises a material having a thermal conductivity of at least 100 W/mK.

49. The aerosolizing element according to claim 47, where the workpiece structure is configured to not directly contact the capsule structure.

50. The aerosolizing element according to claim 47, where the at least one heat-sink structure further comprises a ring-structure and at least one hollow tube structure, and the ring structure and at least one hollow tube structure are coupled together.
